(19) United States
(12) Patent Application Publication
(10) Pub. No.: US 2025/0363542 A1
(43) Pub. Date: Nov. 27, 2025

(54) SYSTEMS AND METHODS FOR INTEGRATING MODELS WITH COORDINATORS AND ARTIFICIAL INTELLIGENCE (AI) AGENTS IN A MARKETPLACE ENVIRONMENT

(71) Applicant: Affle (India) Limited, India, Gurugram (IN)

(72) Inventors: Anuj Khanna SOHUM, Singapore (SG); Charles Yong Jien FOONG, Templestowe (AU); Madhusudana RAMAKRISHNA, Singapore (SG)

(73) Assignee: Affle (India) Limited, India, Gurugram (IN)

(21) Appl. No.: 19/216,241

(22) Filed: May 22, 2025

(30) Foreign Application Priority Data
May 22, 2024 (IN) 202311079234

(51) Int. Cl. G06Q 30/0601; G06Q 30/0201

(52) U.S. Cl. CPC G06Q 30/0631; G06Q 30/0201

(57) ABSTRACT

System and method for integrating models with coordinators and artificial intelligence (AI) agents in a marketplace environment are disclosed. Method comprises receiving, by a primary AI agent, an input from a user. The primary AI agent determines requirements based on the input to identify candidate AI agents based on the set of requirements. The primary AI agent deploy the candidate AI agents for analysis of each candidate AI agent. The primary AI agent evaluates performance of each candidate AI agent based on feedback obtained from monitoring of analysis of the candidate AI agents. The primary AI agent determines an optimal AI agent from the candidate AI agents based on the performance of each candidate AI agent. The primary AI agent obtains recommendation from the optimal AI agent and provides the recommendation to the user.

### CROSS-REFERENCE TO RELATED APPLICATIONS

This patent application claims priority to Indian Patent Application No. IN 202311079234, filed May 22, 2024, entitled “SYSTEMS AND METHODS FOR INTEGRATING MODELS WITH COORDINATORS AND ARTIFICIAL INTELLIGENCE (AI) AGENTS IN A MARKETPLACE ENVIRONMENT,” and assigned to the assignee hereof. The disclosure of the prior application is considered part of and is incorporated by reference in this patent application.

### TECHNICAL FIELD

Embodiments of the present disclosure generally relate to artificial intelligence (AI) based systems and more particularly to systems and methods for integrating models with coordinators and artificial intelligence (AI) agents in a marketplace environment.

### BACKGROUND

In various domains, such as software development, robotics, simulations, and gaming, the integration of models into complex systems is a critical task. Models, in this context, encompass a wide range of data representations, from machine learning models to software templates and more. The effective utilization of these models within a software environment necessitates a comprehensive framework.

Traditionally, these models have been handled separately, often with a focus on either coordination or autonomous agent interactions. Coordinators manage the organization and control aspects of the system. In contrast, agents, as autonomous entities or objects, interact within a given system, performing actions and responding to stimuli. Existing solutions have generally focused on either coordinators or agents, leaving a significant gap in the ability to seamlessly and efficiently integrate both aspects. This lack of a comprehensive framework has hindered the development of systems that require coordinated and interactive elements.

Consequently, there is a need for improved systems and methods for integrating models with coordinators and artificial intelligence (AI) agents in a marketplace environment, to address at least the aforementioned issues of the prior arts.

### OBJECTS OF THE INVENTION

A general objective of the present disclosure is to provide a system and a method for integrating models with coordinators and artificial intelligence (AI) agents in a marketplace environment. The further objectives of present disclosure are discussed below.

Another objective of the present disclosure is to integrate AI models with a plurality of AI agents within a secure cloud-based enclave.

Another objective of the present disclosure is to dynamically integrate, test, and orchestrate a variety of AI agents, including specialized coordinators and recommenders, sourced from marketplaces or external systems.

Another objective of the present disclosure is to instantiate and evaluate multiple candidate secondary agents (or configurations of secondary agents) concurrently or sequentially for a given task.

Yet another objective of the present disclosure is to dynamically engage one or more specialized “Coordinator” agents and specialized “Recommender” agents.

Still another objective of the present disclosure is to facilitate efficient and accurate data exchange between the primary AI agent.

### SUMMARY OF THE INVENTION

Solution to one or more drawbacks of existing technology, and additional advantages are provided through the present subject matter. Additional features and advantages are realized through the technicalities of the present subject matter. Other embodiments and aspects of the subject matter are described in detail herein and are considered to be a part of the claimed subject matter.

In an embodiment, the present invention discloses a method for integrating Artificial Intelligent (AI) models with a plurality of AI agents within a secure cloud-based enclave. The method comprises receiving, by a primary AI agent of the plurality of AI agents, an input from an external system or a user. The method further comprises determining, by the primary AI agent, a set of requirements based on the input. The method further comprises identifying, by the primary AI agent, one or more candidate AI agents from the plurality of AI agents based on the set of requirements. The method further comprises deploying, by the primary AI agent, the one or more candidate AI agents for analysis of each candidate AI agent. The method further comprises evaluating, by the primary AI agent, performance of each candidate AI agent based on feedback obtained from monitoring of analysis of the one or more candidate AI agents. The method further comprises identifying, by the primary AI agent, an optimal AI agent from the one or more candidate AI agents based on the evaluated performance of each candidate AI agent. The method further comprises obtaining, by the primary AI agent, at least one recommendation from the optimal AI agent. The method further comprises providing, by the primary AI agent, at least one recommendation to the external system or the user in response to the input.

In an aspect of the present invention, the feedback comprises at least one of user interaction with recommendations, conversion rates, and stated preferences.

In an aspect of the present invention, the one or more candidate AI agents comprise at least one of specialized AI models, data processing units, coordinators, recommenders, an external marketplace, and integrated systems.

In an aspect of the present invention, the coordinators indicate specialized agents for dynamically manage and consolidate information and actions from multiple AI agents of the plurality of AI agents based on the input and the recommenders indicate specialized agents for generating suggestions or directions based on the input.

In an aspect of the present invention, the feedback comprises at least one of user interaction with recommendations, conversion rates, and stated preferences.

In an aspect of the present invention, the identification of the optimal AI agent is dynamic.

In an aspect of the present invention, the secure cloud-based enclave securely retains the user data within the database without directly exposing to an external AI system.

In an aspect of the present invention, the method further comprises translating, by the primary AI agent, information between the one or more candidate AI agents without loss of semantic meaning of the information.

In an aspect of the present invention, the method further comprises receiving, by the primary AI agent, feedback on at least one recommendation from the user. The method further comprises updating, by the primary AI agent, the confidence score, the reliability score, and the single unified trust matric based on the feedback.

In another embodiment, the present invention discloses a system for integrating Artificial Intelligent (AI) models with a plurality of AI agents within a secure cloud-based enclave. The system comprises one or more processors associated with a primary AI agent of a plurality of AI agents. The system further comprises a memory storing programmed instructions executable by the one or more processors. The one or more processors execute the programmed instructions to receive an input from an external system or a user. The one or more processors are further configured to determine a set of requirements based on the input. The one or more processors are further configured to identify one or more candidate AI agents from the plurality of AI agents based on the set of requirements. The one or more processors are further configured to deploy the one or more candidate AI agents for analysis of each candidate AI agent. The one or more processors are further configured to evaluate performance of each candidate AI agent based on feedback obtained from monitoring of analysis of the one or more candidate AI agents. The one or more processors are further configured to identify an optimal AI agent from the one or more candidate AI agents based on the evaluated performance of each candidate AI agent. The one or more processors are further configured to obtain at least one recommendation from the optimal AI agent. The one or more processors are further configured to provide at least one recommendation to the external system or the user in response to the input.

### BRIEF DESCRIPTION OF THE DRAWINGS

The disclosure will be described and explained with additional specificity and detail with the accompanying figures in which:

FIG. 1 illustrates an exemplary block diagram representation of a network architecture implementing a system for integrating models with coordinators and artificial intelligence (AI) agents in a marketplace environment, in accordance with an embodiment of the present disclosure;

FIG. 2 illustrates an exemplary block diagram representation of a computer implemented system, such as those shown in FIG. 1, capable of integrating models with coordinators and artificial intelligence (AI) agents in a marketplace environment, in accordance with an embodiment of the present disclosure;

FIG. 3 illustrates an exemplary flow diagram representation of interaction between model integration AI agent/personalized AI model with AI/ML agents and coordinators, in accordance with an embodiment of the present disclosure; and

FIG. 4 illustrates a flow chart of a method for integrating AI models with a plurality of AI agents within a secure cloud-based enclave, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide systems and methods for integrating models with coordinators and artificial intelligence (AI) agents in a marketplace environment.

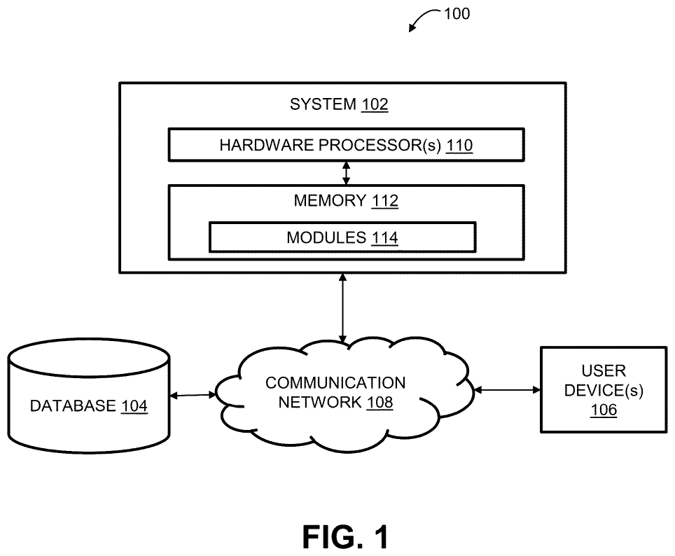

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 implementing a system for integrating models with coordinators and artificial intelligence (AI) agents in a marketplace environment, in accordance with an embodiment of the present disclosure. According to FIG. 1, the network architecture 100 includes the system 102, a database 104, and one or more user devices 106. The one or more user devices 106 may be associated with one or more users, and communicatively coupled to the system 102 via a communication network 108. In an exemplary embodiment of the present disclosure, the user devices 106 may include a laptop computer, desktop computer, tablet computer, smartphone, wearable device, a digital camera, and the like. Further, the communication network 108 may be a wired network or a wireless network. The system 102 may be at least one of, but not limited to, a central server, a cloud server, a remote server, an electronic device, a portable device, and the like. Further, the system 102 may be communicatively coupled to the database 104, via the communication network 108. The database 104 may include, but is not limited to, agent data marketplace data, model data, coordinator data, any other data, and combinations thereof. The database 104 may be any kind of databases/repositories such as, but are not limited to, relational database, dedicated database, dynamic database, monetized database, scalable database, cloud database, distributed database, any other database, and combination thereof.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for integrating models with coordinators and artificial intelligence (AI) agents in a marketplace environment need. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for integrating models with coordinators and artificial intelligence (AI) agents in a marketplace environment. Execution of the machine-readable program instructions by the hardware processor 110 may enable the proposed system 102 to integrate models with coordinators and artificial intelligence (AI) agents in a marketplace environment. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may provide a software development framework for model integration. The system 102 may implement a set of tools and guidelines for developers to streamline the process of building applications. The capability to load various models, including machine learning models, software templates, and data representations, into a software environment.

In an exemplary embodiment, the system 102 may integrate both coordinators and machine learning (ML) agents/artificial intelligence (AI) agents within a unified framework, enabling the efficient coordination and interaction of elements within a system.

In an exemplary embodiment, the system 102 may provide a framework that standardizes common development tasks, reducing redundant efforts in application creation. In an exemplary embodiment, the system 102 may enable the loading of models into a software environment, allowing developers to access and utilize pre-trained machine learning models, software templates, and data formats.

In an exemplary embodiment, the system 102 may facilitate the combination of coordinators and agents within the same software system, enhancing the management and autonomous interaction of components.

In an exemplary embodiment, the system 102 may include ability to load models, such as machine learning models, software templates, and data representations, into a software environment.

The software framework for model integration, configured to load models incorporating both coordinates and agents, enabling coordinated interaction within a software environment such as a commercial marketplace context.

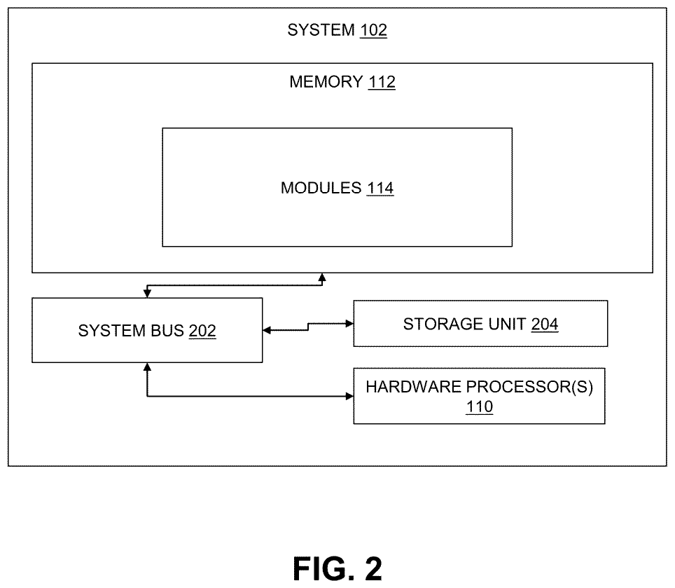

FIG. 2 illustrates an exemplary block diagram representation of a computer implemented system 102, such as those shown in FIG. 1, capable of integrating models with coordinators and artificial intelligence (AI) agents in a marketplace environment, in accordance with an embodiment of the present disclosure. The system 102 may also function as a computer-implemented system/server (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

The one or more hardware processors 110, as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a repository such as those shown in FIG. 1. The storage unit 204 may store, but is not limited to, agent data marketplace data, model data, coordinator data, any other data, and combinations thereof. The storage unit 204 may be any kind of databases/repositories such as, but are not limited to, relational database, dedicated database, dynamic database, monetized database, scalable database, cloud database, distributed database, any other database, and combination thereof.

In an exemplary embodiment, the plurality of modules 114 may provide a software development framework for model integration. The plurality of modules 114 may implement a set of tools and guidelines for developers to streamline the process of building applications. The capability to load various models, including machine learning models, software templates, and data representations, into a software environment.

In an exemplary embodiment, the plurality of modules 114 may integrate both coordinators and machine learning (ML) agents/artificial intelligence (AI) agents within a unified framework, enabling the efficient coordination and interaction of elements within a system.

In an exemplary embodiment, the plurality of modules 114 may provide a framework that standardizes common development tasks, reducing redundant efforts in application creation. In an exemplary embodiment, the plurality of modules 114 may enable the loading of models into a software environment, allowing developers to access and utilize pre-trained machine learning models, software templates, and data formats.

In an exemplary embodiment, the plurality of modules 114 may facilitate the combination of coordinators and agents within the same software system, enhancing the management and autonomous interaction of components.

In an exemplary embodiment, the plurality of modules 114 may include ability to load models, such as machine learning models, software templates, and data representations, into a software environment.

The software framework for model integration, configured to load models incorporating both coordinates and agents, enabling coordinated interaction within a software environment such as a commercial marketplace context.

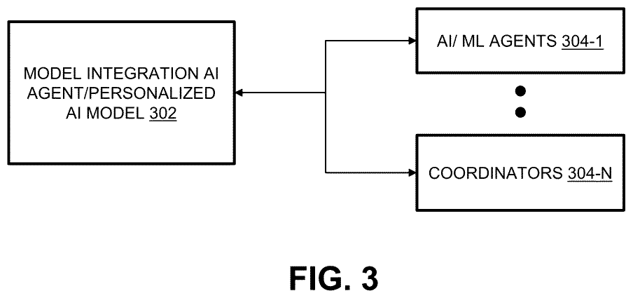

FIG. 3 illustrates an exemplary flow diagram representation of interaction between model integration AI agent/personalized AI model with AI/ML agents and coordinators, in accordance with an embodiment of the present disclosure. A model integration AI agent/personalized AI model 302 (also referred to as primary agent 302 or model integration AI agent 302) may serve as the central decision-maker in this framework which acts as a central intelligence and orchestration layer. The model integration AI agent 302 may initiate the process by conducting a thorough analysis of the system's data and requirements. Based on this analysis, the model integration AI agent/personalized AI model 302 may select appropriate AI and ML models, which can include personalized models crafted for the specific task at hand. If necessary, the AI agent/model 302 may customize these models to align with the system's unique context and objectives, adjusting parameters, data, or architecture as needed. Once these models are prepared, the AI agent/model 302 may deploy them into the system, making them accessible to other components, including the AI/ML agents 304-1 and coordinators 304-N.

Instead of relying on pre-defined internal models exclusively, the model integration AI agent 302 possesses the unique capability to dynamically discover and source a variety of candidate agents (304-1 to 304-N). These agents can be specialized AI/ML models, data processing units, or more complex entities like Coordinators and Recommenders, available from an internal library, an external marketplace, or other integrated systems. The model integration AI agent 302 analyzes the requirements and selects a set of candidate agents that appear suitable for the task at hand. The candidate agents 304-1 play a crucial role in the interaction. They leverage the models selected and deployed by the model integration AI agent 302 to perform various tasks. These tasks can range from data analysis and decision-making to pattern recognition and more. Importantly, AI/ML agents 304-1 operate autonomously based on the models at their disposal, making real-time decisions and executing tasks according to the inputs they receive and the models' outputs. When coordination or management is necessary, the AI/ML agents 304-1 communicate with the coordinators 304-N.

The coordinators 304-N may be responsible for orchestrating the organization and management of the actions within the software system. The coordinators 304-N may ensure that various components work together smoothly and efficiently. This involves task allocation, where the coordinators 304-N assign specific tasks to the AI/ML agents 304-1, considering their capabilities and the system's requirements. Additionally, the coordinators 304-N establish a feedback loop with the AI/ML agents 304-1, allowing them to monitor the agents' actions and provide guidance or adjustments when necessary. This dynamic coordination process ensures that the system performs optimally and aligns with its objectives.

The coordinators are specialized agents (a form of 304-N) that model integration AI agent 302 can dynamically engage to manage and consolidate information and actions from multiple other agents. The recommenders are another type of specialized agent (also a form of 304-N) that model integration AI agent 302 can employ to generate suggestions or decisions, particularly in contexts like shopping.

The communication within this framework extends beyond the AI/ML agents 304-1 and coordinators 304-N. It also involves interaction with the model integration AI agent 302. When changes or updates to the models are required, the coordinators 304-N may communicate with the model integration AI agent 302, requesting modifications to the models to ensure they remain aligned with the evolving needs of the system.

In an embodiment, these agents can also be used to bid for user's attention through a marketplace dynamically, for example a marketplace could be an agent itself that incentivizes users to download other agents and/or recommends products and services.

In an embodiment, marketplace and their products and services could also incentivize users through recommendations, products and services that they provide, give discounts, etc., For example, a Brand's Fridges may provide a cooking application for free but this could recommend other products from the same Brand. Other products may provide an ad support model, for example, Amazon recommendations and receive a referral fee.

A key innovation is the ability of the model integration AI agent 302 to conduct real-time A/B testing (or more complex comparative analyses) with the selected candidate agents (304-1, 304-N). For instance, if multiple recommendation agents are available for a task, agent 302 can deploy them in parallel or sequentially. The model integration AI agent 302 continuously monitors and utilizes feedback from the system (e.g., user interaction with recommendations, conversion rates, stated preferences) to evaluate the effectiveness of each tested agent or combination of agents. Based on this empirical evidence, the model integration AI agent 302 intelligently determines the optimal agent or configuration of agents for the current context and objectives. This selection can be dynamic and change over time.

The system 102 is designed for seamless and lossless information sharing between the model integration AI agent 302 and the dynamically selected agents (304-1, 304-N), as well as among the selected agents themselves when orchestrated by the model integration AI agent 302 or a coordinator. This dynamic orchestration, including the ability to swap agents in and out based on performance and context, without disrupting the overall service or losing critical information, is a core inventive step.

All interactions would occur within a secure cloud-based enclave. This would necessitate secure APIs, strong authentication/authorization, data encryption, potential sandboxing for external agents, and robust consent/privacy management. “The specific operational framework and communication protocols of this secure cloud-based enclave ensures the privacy and integrity of data during interactions with dynamically sourced external agents. This includes defined protocols for secure agent registration, capability verification, encrypted data exchange channels for inputs, outputs, and feedback, and auditable logs of agent interactions, all designed to protect user data from direct exposure to external AI systems while enabling the dynamic functionalities of the Model Integration AI Agent 302. For instance, external agents might operate within sandboxed environments with strictly controlled data access permissions managed by the enclave, based on consent and the principle of least privilege.

Let's illustrate with a user wanting to find a birthday gift for her teenage son, and also explore ideas for a family weekend activity. The goal for this example is to assist the user in finding a suitable birthday gift for her son and suggest engaging in family weekend activities, potentially involving purchases. For the gift, the model integration AI agent 302 identifies potential Shopping Recommender agents (specialized in electronics, fashion, books, experiences-a type of 304-N), individual e-commerce store agents (local specialty shops-types of 304-1), product review aggregator agents, and price comparison agents. For family activity planning, the model integration AI agent 302 identifies experience provider agents (e.g., movie ticketing agent, local events agent, restaurant booking agent-types of 304-1), and crucially, the “Family Coordinator” agent (a specialized 304-N type).

The user mentions her son is into gaming and music. The model integration AI agent 302 selects three different Shopping Recommender agents. Recommender A focuses on latest tech gadgets. Recommender B specializes in curated music-related items (vinyl, headphones, concert tickets). Recommender C offers a mix but with a focus on user reviews.

The model integration AI agent 302 can present a few top suggestions from each Recommender to the user, or it can internally score the recommendations based on criteria derived from the Family Coordinator (e.g., son's past wish lists, items already owned). The user's interaction (clicking on certain items, dismissing others) provides feedback, allowing the model integration AI agent 302 to learn which Recommender (or combination of insights) is most effective for this specific user and context.

A Family Coordinator Agent (304-N type) is central to providing deep personalization. The Family Coordinator (with prior consent) accesses information like “the son's public wish lists on e-commerce sites”, “mentions of desired items in family chat logs (e.g., “I wish I had those new headphones”), “his current subscriptions (to avoid duplicate game purchases)”, “family budget guidelines for gifts, if set”, and “preferences of other family members if it's a joint gift”.

Further, for planning a family weekend, the Family Coordinator provides insights on “shared family calendar availability”, “preferences of each family member (e.g., daughter prefers outdoors, son prefers tech-related events, parents prefer relaxing activities)”, “past successful/unsuccessful family outings”, and “the family's current location (via user device 106) to suggest local options”.

This agent, selected by the model integration AI agent 302 (possibly after A/B testing), takes user's initial query (“gift for teenage son”) and the rich contextual data from the Family Coordinator. It then orchestrates queries to multiple underlying e-commerce store agents (304-1s), review aggregators, and price checkers. For instance, it might find a specific gaming headset mentioned by the son (via Family Coordinator), check its reviews via a review agent, and find the best price across several store agents. It presents a consolidated, ranked list of gift options back to the model integration AI agent 302, which then relays it to the user.

This agent uses input from the Family Coordinator (schedules, preferences) and user's explicit criteria (e.g., “something for this Saturday”). It might query movie ticketing agents, local event listing agents, park information agents, and restaurant booking agents (all 304-1). It could then present a few tailored options: “Family movie night (movie X is playing, good reviews, fits schedule), followed by dinner at Restaurant Y (good family reviews, budget-friendly)” or “Hike at National Park Z (daughter will love it, weather permitting-checked via a weather agent).”

The model integration AI agent 302 ensures all this information flows securely. The Family Coordinator's sensitive data is only shared with trusted, vetted Recommender agents as needed and with consent. If the user likes a gift idea, Agent 302 can seamlessly transition to the selected e-commerce store agent for purchase.

If a new, highly-rated local electronics store agent becomes available on the marketplace, the model integration AI agent 302 can dynamically add it to the roster of agents queried by the Shopping Recommender for future gift searches, ensuring the user always gets the best, most current options. The “baking in” of this dynamic capability means that if the user later asks for a gift for her daughter, the model integration AI agent 302, using the Family Coordinator and dynamically selected Recommenders, will provide an entirely different, equally personalized set of suggestions without needing to be re-programmed.

This shopping and family activity planning example clearly demonstrates how the model integration AI agent 302 acts as an intelligent orchestrator, leveraging a dynamic ecosystem of specialized agents (including Coordinators and Recommenders) sourced from a marketplace, using A/B testing and feedback to optimize outcomes, all while maintaining security and privacy. This highlights the novelty of the system 102 in providing a truly adaptive and context-aware intelligent assistant.

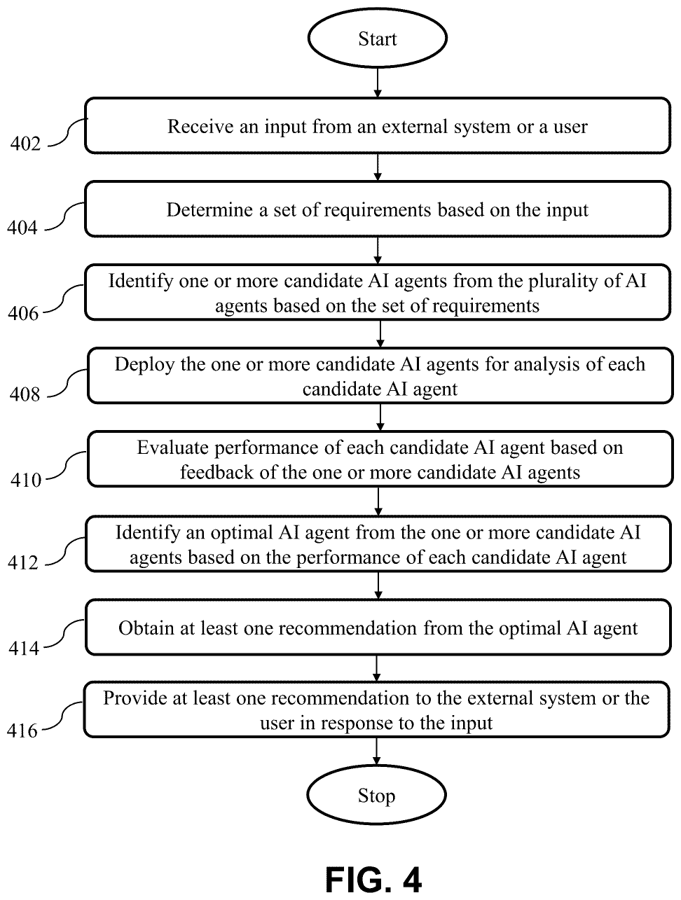

FIG. 4 illustrates a flow chart of a method 400 for integrating AI models with a plurality of AI agents within a secure cloud-based enclave, in accordance with an embodiment of the present disclosure. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved.

At block 402, the primary AI agent 302 present within a secure cloud-based enclave may receive an input from an external system or a user. The secure cloud-based enclave securely retains the user data within the database without directly exposing to an external AI system. At block 404, the primary AI agent 302 may determine a set of requirements based on the input.

At block 406, the primary AI agent 302 may identify one or more candidate AI agents 304 from the plurality of AI agents based on the set of requirements. The one or more candidate AI agents 304 may comprise at least one of specialized AI models, data processing units, coordinators, recommenders, an external marketplace, and integrated systems. The coordinators may indicate specialized agents for dynamically manage and consolidate information and actions from multiple AI agents of the plurality of AI agents based on the input. The recommenders may indicate specialized agents for generating suggestions or directions based on the input.

At block 408, the primary AI agent 302 may deploy the one or more candidate AI agents 304 for analysis of each candidate AI agent. At block 410, the primary AI agent 302 may evaluate performance of each candidate AI agent 304 based on feedback obtained from monitoring of analysis of the one or more candidate AI agents 304. The feedback may comprise at least one of user interaction with recommendations, conversion rates, and stated preferences.

At block 412, the primary AI agent 302 may identify an optimal AI agent from the one or more candidate AI agents 304 based on the evaluated performance of each candidate AI agent 304. The identification of the optimal AI agent may be dynamic.

At block 414, the primary AI agent 302 may obtain at least one recommendation from the optimal AI agent. At block 416, the primary AI agent 302 may provide at least one recommendation to the external system or the user in response to the input. Furthermore, the primary AI agent 302 may translate information between the one or more candidate AI agents 304 without loss of semantic meaning of the information.

Exemplary Interaction Process Between Model Integration AI Agent with AI Agents and Coordinators:

For example, the model integration AI agent 302 may take the lead, conducting a comprehensive analysis of the system's data and requirements. This analysis involves understanding the specific tasks at hand, the objectives of the system 102, and the nature of the data to be processed. Based on the analysis, the model integration AI agent 302 may select the most appropriate AI and ML models for the tasks. These models can include both pre-trained models and personalized models. If needed, the AI agent 304-1 customizes these models, fine-tuning parameters, training data, or model architecture to ensure they align with the system's unique context and objectives.

With the models selected and potentially customized, they are deployed within the software system, making them accessible to the system's components, including the model integration AI agent 302 and coordinators 304-N. The coordinators 304-N play a pivotal role in the interaction. They are responsible for the organization and management of the system's actions. They assess the system's current state and requirements and allocate tasks to the model integration AI agent 302 based on their capabilities and the specific needs of the system 102. This task allocation ensures that different components work in harmony to achieve the system's objectives.

The AI/ML Agents 304-1 interact with the deployed models to perform various tasks. For example, an AI agent responsible for data analysis may utilize the models to process incoming data and extract insights, while another AI agent may use the models for real-time decision-making in response to system inputs. Importantly, these AI agents operate autonomously based on the models at their disposal. They make real-time decisions and execute tasks independently, without constant human intervention.

Coordinators 304-N maintain a dynamic coordination process through a feedback loop with AI/ML agents 304-1. This feedback loop allows the coordinators 304-N to monitor the progress and actions of the agents and to provide guidance or adjustments when required. Furthermore, based on feedback received from the AI/ML agents 304-1 and the evolving needs of the system, coordinators 304-N may communicate with the model integration AI agent/personalized AI agent 302. This communication can involve requests for updates or modifications to the AI and ML models to ensure they align with the changing requirements of the system.

### Exemplary Scenario 1:

Consider a scenario of AI development marketplace. The AI development landscape is constantly evolving, with businesses and developers seeking advanced tools to streamline their AI and software development projects. In this context, an AI development marketplace is established to offer a ground-breaking framework capable of loading models with both coordinates and agents, a feature not previously available in a commercial marketplace. For example, robotics company is developing autonomous delivery robots for a range of industries, including e-commerce and healthcare. They require a framework that can integrate models with spatial coordinates for navigation and AI agents for dynamic obstacle avoidance and path planning. The robotics company visits the AI development marketplace and explores the innovative framework's capabilities. They find and license the framework, allowing them to load the necessary models seamlessly. With the framework in place, the robotics company can build highly efficient autonomous robots that navigate complex environments using spatial coordinates and interact with their surroundings through dynamic AI agents. This results in more reliable and safer robotic systems for various applications.

In other scenario, a game development studio is creating an open-world video game with intricate ecosystems and dynamic AI-driven non-player characters (NPCs). They require a solution that integrates models with spatial coordinates for map design and AI agents for lifelike NPC behaviors. The game development studio discovers the AI Development Marketplace and acquires the innovative framework. They use it to load models that incorporate spatial coordinates for world building and AI agents to bring NPCs to life. The game development studio leverages the framework to create a visually stunning and immersive gaming experience. The NPCs interact with the game world intelligently, making the gameplay more engaging and lifelike.

### Exemplary Scenario 2:

Consider, another scenario of autonomous traffic management system. In a bustling metropolis, a cutting-edge autonomous traffic management system (ATMS) has been deployed to address traffic congestion and enhance the safety of city streets. The ATMS operates through a sophisticated interplay of advanced AI components, which include the model integration ai agent, ai agents, and coordinators, all working in harmony to achieve the system's objectives.

The system's journey commences with its initialization, where the model integration AI agent 302 takes the lead. It actively assesses the real-time data concerning traffic flow, weather conditions, and the city's intricate road infrastructure. This thorough analysis serves as the foundation for the system's operation. With data insights in hand, the AI agent 302 recognizes the need for a combination of AI and ML models. It selects pre-trained models for traffic prediction, congestion detection, and autonomous traffic signal control. However, recognizing the uniqueness of the city's traffic patterns and road infrastructure, the AI agent 302 does not stop at model selection. It goes a step further, customizing these models to seamlessly adapt to the city's specific context and objectives.

The city's coordinators 304-N, strategically positioned within the traffic management network, come into play. They diligently assess traffic conditions within their designated areas of responsibility. Based on their assessments, the coordinators 304-N adeptly allocate tasks to AI agents 302. For instance, an AI agent specialized in traffic signal control is assigned to manage an intricate intersection, while another AI Agent, with expertise in congestion detection, is dispatched to monitor the bustling city highways.

The AI/ML agents 304-1, now empowered by the deployed models, spring into action. Each agent meticulously interacts with these models to perform their designated tasks. For instance, the traffic signal control AI agent gains access to traffic prediction models, allowing it to dynamically optimize signal timing to alleviate traffic congestion during peak hours. Meanwhile, the congestion detection AI agent employs its models to promptly identify traffic bottlenecks, enabling real-time alerts to be issued to fellow drivers and law enforcement.

The hallmark of this system is the autonomy granted to these AI/ML agents 304-1. They operate independently, making real-time decisions and executing tasks with minimal human intervention. The traffic signal control AI agent 302 intelligently adapts signal timings based on current traffic volumes, while the congestion detection AI Agent communicates with emergency services and swiftly reroutes traffic around accidents. The coordination aspect of this system is entrusted to the coordinators 304-N, who maintain a dynamic coordination process. They maintain an open line of communication with AI agents 302 to ensure optimal and efficient operations. For instance, they synchronize traffic signal adjustments across multiple intersections to harmonize traffic flow across the sprawling metropolis.

The feedback loop is critical in this dynamic system. Coordinators 304-1, informed by feedback from AI/ML agents 304-N and real-time data, communicate with the Model Integration AI agent 302 to request updates to AI and ML models. These updates serve to keep the system aligned with changing traffic patterns, evolving road infrastructure, and new developments within the city.

The present disclosure provides a method and a system 102 for integrating AI models with a plurality of AI agents within the secure cloud-based enclave. A system where a primary AI agent (Model Integration AI Agent 302) dynamically discovers, selects, and integrates a plurality of secondary, functionally distinct AI agents (e.g., AI/ML agents 304-1, specialized Coordinator agents 304-N, specialized Recommender agents 304-N). These secondary agents 304 can be sourced from various locations, including an internal library, an external marketplace, or other third-party systems. The selection is based on the current task, context, or requirements analyzed by the primary AI agent 302. Traditional AI systems often have fixed components or require manual reconfiguration to change underlying models or logic. This invention allows for on-the-fly adaptation by composing solutions from the best available agents. The invention further solves the inability of existing systems to easily leverage a diverse and evolving ecosystem of specialized AI capabilities without significant redevelopment. Furthermore, the invention addresses the issue where a general-purpose model or a pre-selected specialized model might not be the best fit for a specific, nuanced task. The system 102 can dynamically find a more suitable agent.

Many systems rely on predetermined agent choices. This invention allows for data-driven selection of the most effective agents in a live environment, leading to continuous improvement and self-optimization. If a previously optimal agent's performance degrades, this system 102 can detect it and find a better alternative dynamically. Furthermore, the system 102 removes guesswork by providing a mechanism to test and validate agent performance for specific scenarios before full deployment or during runtime.

The present invention further addresses the difficulty in creating truly intelligent AI assistants that can understand and act upon the complex, multifaceted contexts of a user's life (e.g., understanding family dynamics, preferences, and schedules for making relevant suggestions). The invention moves beyond simple personalization based on direct user input, enabling deeper understanding by consolidating implicit and explicit information from various facets of a user's environment or social graph. Furthermore, the present invention provides a structured way for the primary agent to leverage specialized agents whose sole purpose is to build and maintain rich contextual models.

The present invention further overcomes the limitations of recommendation systems that rely on a narrow set of inputs or a single algorithmic approach. Furthermore, the present invention allows the system 102 to choose or combine different recommendation strategies or access varied product/service inventories dynamically based on the specific query and user context. The present invention provides a way to consolidate information from various sources (different shops, review sites, etc.) into a cohesive and actionable recommendation.

The present invention reduces the complexity and potential for error when combining disparate AI services. Furthermore, the present invention allows for agile evolution of the system's capabilities by swapping components without major disruptions. In addition, the present invention ensures that relevant information and learned context are maintained and leveraged even when different agents are brought into play dynamically.

Existing approaches often require extensive manual configuration or lack a central intelligent orchestrator capable of dynamic, adaptive behavior. Furthermore, the present invention provides a framework to bring together narrow AI tools to solve broader, more complex problems in a coherent way.

A key inventive step could be that the model integration AI agent 302 learns and adapts its orchestration strategies, its A/B testing methodologies, its preferences for sourcing certain types or characteristics of secondary agents (304-1, 304-N), and its interaction patterns based on its cumulative experience with a specific user or evolving contexts.

The present invention provides a solution that is beyond simply using personalized data. It is about the meta-level learning and personalization of the orchestrator's behavior and decision-making framework. The model integration AI agent 302 could develop a unique “style” of problem-solving or agent composition tailored to individual user needs or evolving enterprise goals, making its orchestration increasingly efficient and effective over time for that specific entity.

The present invention addresses the limitation of orchestrators that use fixed logic or require manual tuning for different users/contexts. It creates a truly co-adaptive system where the central intelligence evolves alongside the user or environment it serves.

The nature and depth of the feedback loop used by the model integration AI agent 302 for A/B testing and agent selection. This isn't just about simple metrics. It could involve multiple items, for example, multi-modal feedback and multi-objective optimization. In the multi-modal feedback, several processes may be performed, such as combining explicit user ratings, implicit signals (e.g., task completion time, hesitation scores, biometric responses if available from user device 106), goal attainment success, resource consumption by secondary agents, and qualitative feedback processed via NLP. In multi-objective optimization, the model integration AI agent 302 might not just optimize for “best performance” but could balance multiple, potentially conflicting objectives, such as performance, cost of using marketplace agents, user satisfaction, ethical considerations, or energy efficiency. The ability to dynamically weigh these objectives based on user preferences or system policies would be highly inventive. The advanced capability of the model integration AI agent 302 to intelligently process diverse feedback types and perform sophisticated multi-objective optimization when selecting and configuring external agents. In view of the above, the present invention overcomes simplistic A/B testing that optimizes for a single metric. It allows for a more nuanced and contextually appropriate selection of agents, leading to solutions that are not just effective but also efficient, cost-effective, and aligned with broader user or system values.

The specific technical mechanisms that enable truly “lossless information sharing” and dynamic integration of heterogeneous agents from a marketplace. This could involve, a defined, rich, and extensible API or communication protocol that all marketplace agents (304-1 to 304-N, including Coordinators and Recommenders) must adhere to for interaction with the model integration AI agent 302. This could further involve a canonical data model or ontology managed or understood by the model integration AI agent 302, allowing it to mediate and translate information between diverse agents without loss of semantic meaning. Furthermore, this could involve mechanisms for capability negotiation and discovery where the model integration AI agent 302 can query agents about their specific skills, input/output formats, and performance characteristics before selecting them. The design of the interface, protocol, and data management strategies that make the dynamic plug-and-play of diverse, externally sourced AI agents truly seamless and semantically coherent. In view of the above, the present invention addresses the significant integration challenges (the “glue” problem) in multi-agent systems, especially when dealing with agents from different providers. It enables a truly open and interoperable AI agent marketplace.

The capability for the intelligent configuration created by the model integration AI agent 302 (i.e., the specific combination of selected secondary agents, their optimized parameters, and the orchestration logic for a particular complex task or user profile) to be saved, versioned, and potentially transferred or shared. The model integration AI agent 302 doesn't just provide a service; it can generate a transferable, composite AI asset. For example, a highly effective personalized shopping assistant configuration (composed by the model integration AI agent 302 for a user) could potentially be (with consent and privacy safeguards) transferred to another user (with similar needs) as a starting point, or a “snapshot” of an enterprise's optimal customer service agent configuration could be deployed to a new region. In view of the same, facilitates reusability and efficient deployment of complex, optimized AI solutions. It allows successful, personalized AI configurations to be leveraged more broadly, reducing the learning curve or setup time for new instances or users.

The model integration AI agent 302 manages the ongoing relationship with and reliability of dynamically sourced marketplace agents. This involves maintaining a trust or reputation score for marketplace agents based on past performance, user feedback, security audits, or external ratings. This further involves detecting when agents are updated, deprecated, or become unavailable, and proactively finding alternatives. This further involves considering cost-benefit analysis in real-time, potentially switching between functionally similar agents based on dynamic pricing or API usage costs from the marketplace. The proactive governance and intelligent management layer within Agent 302 that ensures the quality, reliability, security, and cost-effectiveness of the solutions it composes from marketplace agents. In view of the above, the present invention mitigates risks associated with relying on an ecosystem of external agents (e.g., performance variability, security vulnerabilities, unpredictable costs, agent churn). It adds a layer of resilience and intelligent sourcing to the orchestration process.

For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules 114.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

Embodiments of the present disclosure provide systems and methods for integrating models with coordinators and artificial intelligence (AI) agents in a marketplace environment. The present disclosure provides a framework, providing developers with a robust set of tools and guidelines. This empowers developers to streamline the process of building applications, reducing development time and effort, and ultimately accelerating the delivery of software solutions to market. A key strength of this system is its ability to load a diverse array of models into a software environment. These models encompass various categories, including machine learning models, software templates, and data representations. This versatility allows developers to choose the most appropriate models for their specific applications, fostering flexibility and functionality in their projects. Developers can seamlessly access and utilize pre-trained machine learning models, software templates, and data formats, thereby reducing the need to create components from scratch and facilitating rapid development. Moreover, the system integration of both coordinators and machine learning (ML) agents/artificial intelligence (AI) agents within a unified framework is a ground-breaking feature. It enables efficient coordination and interaction among elements within a software system. This coordination optimizes resource management, ensuring that software systems can adapt to changing conditions and make real-time decisions with efficiency and precision. The present disclosure integrates coordinators and agents within the same software environment. This innovation enhances the management and autonomous interaction of components. Coordinators can effectively oversee and optimize the actions of AI agents, resulting in more efficient and intelligent software systems. This autonomous capability is particularly beneficial in applications where real-time decision-making is required. The present disclosure provides an applicability in a commercial marketplace context is a significant advantage. It empowers businesses and developers to gain a marketplace edge by offering innovative, market-differentiating solutions.

The written description describes the subject matter herein to enable any person skilled in the art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

1. A method for integrating Artificial Intelligent (AI) models with a plurality of AI agents within a secure cloud-based enclave, comprising:
receiving, by a primary AI agent of the plurality of AI agents, an input from an external system or a user;
determining, by the primary AI agent, a set of requirements based on the input;
identifying, by the primary AI agent, one or more candidate AI agents from the plurality of AI agents based on the set of requirements;
deploying, by the primary AI agent, the one or more candidate AI agents for analysis of each candidate AI agent;
evaluating, by the primary AI agent, performance of each candidate AI agent based on feedback obtained from monitoring of analysis of the one or more candidate AI agents;
identifying, by the primary AI agent, an optimal AI agent from the one or more candidate AI agents based on the evaluated performance of each candidate AI agent;
obtaining, by the primary AI agent, at least one recommendation from the optimal AI agent; and
providing, by the primary AI agent, at least one recommendation to the external system or the user in response to the input.

2. The method according to claim 1, wherein the one or more candidate AI agents comprise at least one of specialized AI models, data processing units, coordinators, recommenders, an external marketplace, and integrated systems.

3. The method according to claim 2, wherein
the coordinators indicate specialized agents for dynamically manage and consolidate information and actions from multiple AI agents of the plurality of AI agents based on the input, and
the recommenders indicate specialized agents for generating suggestions or directions based on the input.

4. The method according to claim 1, wherein the feedback comprises at least one of user interaction with recommendations, conversion rates, and stated preferences.

5. The method according to claim 1, where the identification of the optimal AI agent is dynamic.

6. The method according to claim 1, wherein the secure cloud-based enclave securely retains the user data within the database without directly exposing to an external AI system.

7. The method according to claim 1, further comprising translating, by the primary AI agent, information between the one or more candidate AI agents without loss of semantic meaning of the information.

8. A system for integrating Artificial Intelligent (AI) models with a plurality of AI agents within a secure cloud-based enclave, comprising:
one or more processors associated with a primary AI agent of a plurality of AI agents; and
a memory storing programmed instructions executable by the one or more processors, wherein the one or more processors execute the programmed instructions to:
receive an input from an external system or a user;
determine a set of requirements based on the input;
identify one or more candidate AI agents from the plurality of AI agents based on the set of requirements;
deploy the one or more candidate AI agents for analysis of each candidate AI agent;
evaluate performance of each candidate AI agent based on feedback obtained from monitoring of analysis of the one or more candidate AI agents;
identify an optimal AI agent from the one or more candidate AI agents based on the evaluated performance of each candidate AI agent;
obtain at least one recommendation from the optimal AI agent; and
provide at least one recommendation to the external system or the user in response to the input.

9. The system according to claim 8, wherein the one or more candidate AI agents comprise at least one of specialized AI models, data processing units, coordinators, recommenders, an external marketplace, and integrated systems.

10. The system according to claim 9, wherein
the coordinators indicate specialized agents for dynamically manage and consolidate information and actions from multiple AI agents of the plurality of AI agents based on the input, and
the recommenders indicate specialized agents for generating suggestions or directions based on the input.

11. The system according to claim 8, wherein the feedback comprises at least one of user interaction with recommendations, conversion rates, and stated preferences.

12. The system according to claim 8, where the identification of the optimal AI agent is dynamic.

13. The system according to claim 8, wherein the secure cloud-based enclave securely retains the user data within the database without directly exposing to an external AI system.

14. The system according to claim 8, wherein the one or more processors are configured to translate information between the one or more candidate AI agents without loss of semantic meaning of the information.

15. A non-transitory machine-readable medium including data, which when used by a system for integrating Artificial Intelligent (AI) models with a plurality of AI agents within a secure cloud-based enclave, causes the system to perform instructions that cause the system to perform operations comprising:
receiving, by a primary AI agent of the plurality of AI agents, an input from an external system or a user;
determining, by the primary AI agent, a set of requirements based on the input;
identifying, by the primary AI agent, one or more candidate AI agents from the plurality of AI agents based on the set of requirements;
deploying, by the primary AI agent, the one or more candidate AI agents for analysis of each candidate AI agent;
evaluating, by the primary AI agent, performance of each candidate AI agent based on feedback obtained from monitoring of analysis of the one or more candidate AI agents;
identifying, by the primary AI agent, an optimal AI agent from the one or more candidate AI agents based on the evaluated performance of each candidate AI agent;
obtaining, by the primary AI agent, at least one recommendation from the optimal AI agent; and
providing, by the primary AI agent, at least one recommendation to the external system or the user in response to the input.
